(19) United States
(12) Patent Application Publication
(10) Pub. No.: US 2014/0071157 A1
(43) Pub. Date: Mar. 13, 2014

(54) CONTENT DELIVERY SYSTEMS WITH PRIORITIZED CONTENT AND RELATED METHODS

(71) Applicants: Gregory A. Dunko, Cary, NC (US); Charles Curtiss Hunt, Wake Forest, NC (US)

(72) Inventors: Gregory A. Dunko, Cary, NC (US); Charles Curtiss Hunt, Wake Forest, NC (US)

(73) Assignee: HTC CORPORATION, Taoyuan City (TW)

(21) Appl. No.: 13/606,597

(22) Filed: Sep. 7, 2012

(51) Int. Cl. G09G 5/00

(52) U.S. Cl. 345/619

(57) ABSTRACT

Content delivery systems and related methods are provided. In this regard, a representative system includes: a content hosting system having a wireless communication interface for communicating with mobile devices, the content hosting system being operative to: receive information corresponding to a first content item via the wireless communication interface; associate a first time indicator with the first content item; and provide the first content item to a display device such that multiple content items are displayed in a time-prioritized configuration.

### TECHNICAL FIELD

The present disclosure generally relates to displaying of content.

### BACKGROUND

Display devices (e.g., touchscreen displays) provide users with the ability to view content, such as text and other images. However, it is difficult to aggregate content for display in a display device that is easily accessible to a user while, at the same time, permitting the user to filter the content based on personal preferences.

### SUMMARY

Content delivery systems with prioritized content and related methods are provided. Briefly described, one embodiment, among others, is a content delivery system comprising: a content hosting system having a wireless communication interface for communicating with mobile devices, the content hosting system being operative to: receive information corresponding to a first content item via the wireless communication interface; associate a first time indicator with the first content item; and provide the first content item to a display device such that multiple content items are displayed in a time-prioritized configuration.

Another embodiment is a method for displaying prioritized content comprising: receiving, via a wireless communication interface, information corresponding to multiple content items from at least a first mobile device; and displaying, via a display device, the multiple content items in a time-prioritized configuration, in which a first of the content items is displayed in front of at least a portion of a second of the content items, the first of the content items having been received more recently than the second of the content items.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a content delivery system.

FIG. 2 is a flowchart depicting an example embodiment of a method for displaying prioritized content.

FIG. 3 is a schematic diagram of another example embodiment of a content delivery system.

FIG. 4 is a flowchart depicting functionality that may be performed by an example embodiment of a content hosting system.

FIG. 5 is a schematic diagram of an example embodiment of a content posting system interacting with a content hosting system.

FIG. 6 is a flowchart depicting functionality that may be performed by an example embodiment of a content posting system.

FIG. 7 is a schematic diagram of an example embodiment of a content downloading system interacting with a content hosting system.

FIG. 8 is a flowchart depicting functionality that may be performed by an example embodiment of a content downloading system.

FIGS. 9A and 9B are schematic diagrams of an example embodiment of a content hosting system interacting with users.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, content delivery systems with prioritized content and related methods are provided, some embodiments of which involve the use of interactive display devices for displaying multiple content items simultaneously to multiple users. In particular, the content items (i.e., displayable information), which may contain metadata to facilitate searching, are displayed in a time-prioritized configuration on a display device. For instance, more recently received content items may be presented, at least partially, in front of previously received content items. Clearly, the arrangement of content items for viewing on a display may be accomplished in numerous manners based, at least in part, on one or more of numerous considerations. In some embodiments, the time-prioritized configuration of content items involves removing content items from the display responsive to evaluation of a time indicator. By way of example, a time indicator may correspond to an expiration date for removal of a content item; whereas a time indicator of another content item may be used to determine that a predetermined display duration has elapsed.

In some embodiments, expiration may be based upon level of activity. For example, a content item may not be able to be “covered” by another content item until a certain number of new postings has been exceeded. For instance, a content item associated with a band concert may not be covered up until after a preset number of other concert postings has been exceeded (i.e., the system prevents a content item from covering the content item associated with the concert for until the count indicator enables that function).

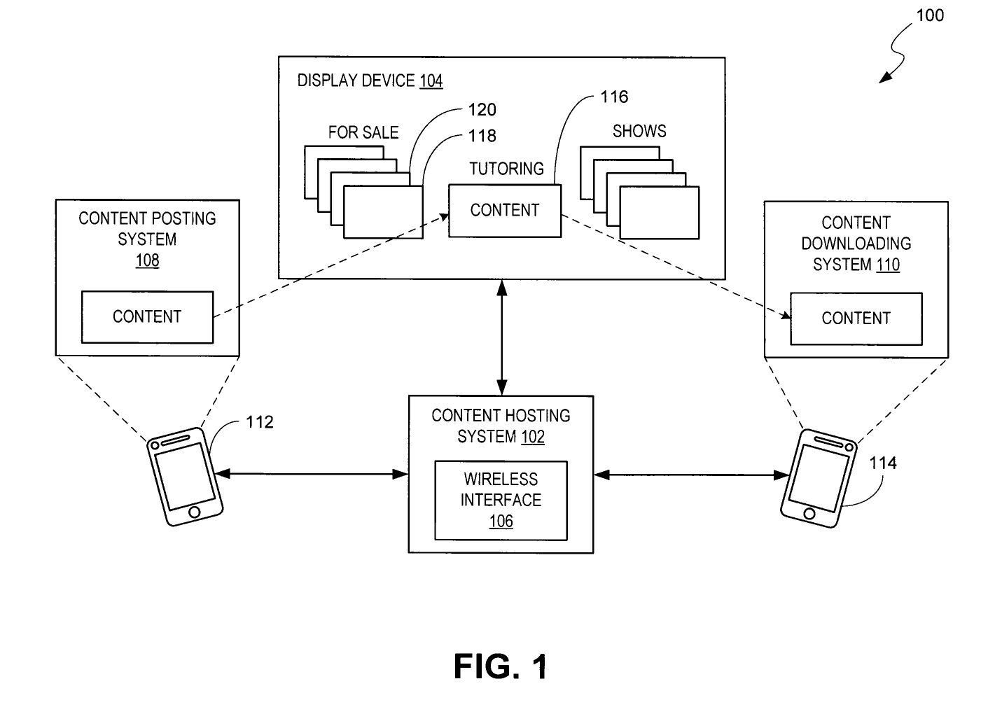

FIG. 1 is a schematic diagram of an example embodiment of a content delivery system. As shown in FIG. 1, system 100 includes a content hosting system 102 (which incorporates a display device 104 and a wireless communication interface 106), a content posting system 108 and a content downloading system 110. In this embodiment, the content posting system is resident on a mobile device 112 (e.g., a smartphone) and the content downloading system is resident on a mobile device 114. It should be noted that although only one content posting system and one content downloading system are depicted in FIG. 1, multiple instances of each of these systems may interact with a single content hosting system.

In operation, the display device displays content items that are provided to content hosting system 102 by a content positing system, such as content posting system 108. For instance, information corresponding to content item 116 is communicated from mobile device 112 to content hosting system 102. Responsive to receiving the information, the content hosting system formats the information for display, such as by configuring the information for placement within the display area of the display device.

In the embodiment of FIG. 1, content items are arranged by category (e.g., type) and by order of receipt by the content hosting system. Thus, within each category that includes more than one content item, a newer content item (e.g., content item 118) is displayed in front of at least a portion of an older content item (e.g., content item 120). Note that, as space permits, the newer content item may move to its own open space rather than in front of (or partially in front of) some other content item. Thus, in some embodiments, auto-placement (or rearrangement) based on open space may occur.

In other embodiments, the displaying of content items may be performed in a manner that is directed by the user who is posting the content item. By way of example, in some embodiments, a user may direct where on the display that a content item is to be displayed. For instance, in some embodiments, the system may choose an initial location for the content item to be displayed and, thereafter, the content item may be highlighted to indicate that it can be moved, and then the user may direct where the content item is to be placed (such as by dragging the content item across the display). Additionally or alternatively, the system may keep track of what items are placed where, what items have “expired” and thus have opened up display space, and/or what items are oldest and may be “pasted” over with newer content items.

Content hosting system 102 may also remove content items from display responsive to evaluation of a time indicator (not shown and which may be stored in a database, for example) that is associated with the content item. In some embodiments, the content hosting system may associate a time indicator with a content item. For instance, when the time indicator is to function as a form of expiration date after which the content item is no longer to be displayed, the content hosting system may associate a time indicator that incorporates the expiration date with the content item. Additionally, or alternatively, when the time indicator is to function as a form of display duration counter, the content hosting system may associate a time indicator that incorporates a predetermined display duration with the content item. Regardless of the manner in which a time is determined for discontinuing display of a content item, responsive to such a determination, the content hosting system ensures that the content item is no longer displayed. Notably, the use of this temporal form of expiration may be useful with various content items, such as those associated with events or travel dates, for example.

Other forms of expiration of content items also may be used. As an example, expiration of a content item may occur responsive to the content item being copied a predetermined number of times. It should be noted that the term “expired” may correspond to a range of settings. For instance, an expired content item may be one that has been entirely deleted from the system (i.e., unretrievable), while another may be removed from display (yet may still be searchable), while yet another may be displayed and somehow annotated as “expired”.

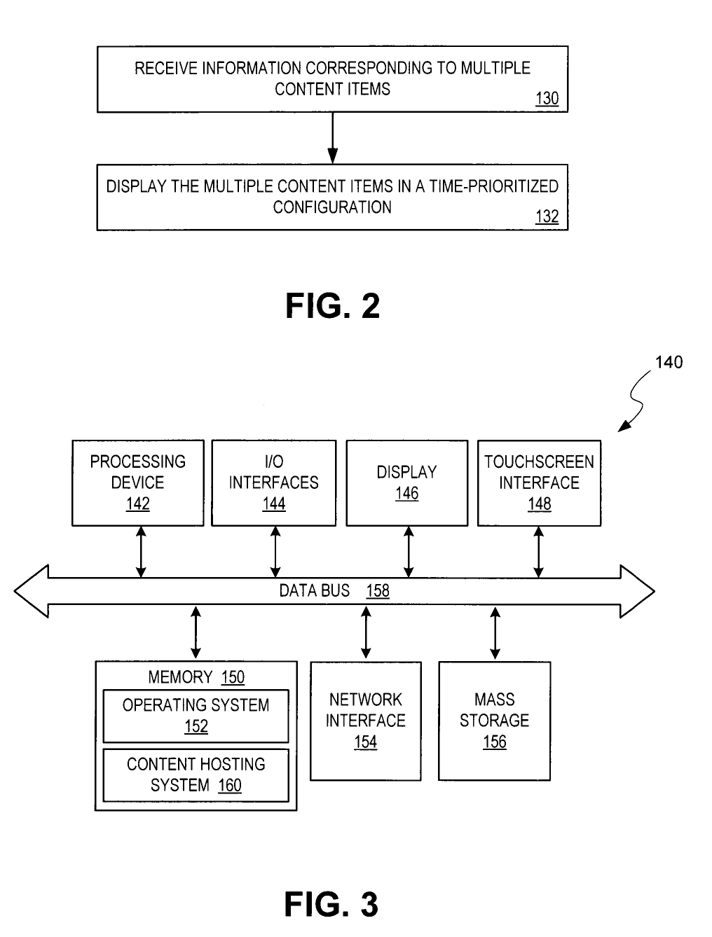

FIG. 2 is a flowchart depicting an example embodiment of a method for displaying prioritized content, such as may be performed by a content delivery system. As shown in FIG. 2, the method involves receiving information corresponding to multiple content items (block 130). In some embodiments, the information is received from at least a one mobile device via wireless communication. In block 132, the multiple content items are displayed in a time-prioritized configuration by a display device. In some embodiments, this may include displaying a recently received content item in front of at least a portion of a previously received content item.

FIG. 3 is a schematic diagram of portion of an example embodiment of a content delivery system. As shown in FIG. 3, content delivery system 140 includes a processing device (processor) 142, input/output interfaces 144, a display device 146, a touchscreen interface 148, a memory 150, operating system 152, a network interface 154, and a mass storage 156, with each communicating across a local data bus 158. Additionally, the system incorporates a content hosting system 160.

The processing device 142 may include any custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 150 can include any one of a combination of volatile memory elements (e.g., random-access memory (RAM, such as DRAM, and SRAM, etc.)) and nonvolatile memory elements. The memory typically comprises native operating system 152, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device. Note that although depicted as being resident in memory 150, content hosting system 160 may be stored separately.

Touchscreen interface 148 is configured to detect contact within the display area of the display 146 and provides such functionality as on-screen buttons, menus, keyboards, etc. that allows users to navigate user interfaces by touch. Notably, navigating via the touchscreen interface may facilitate various functions associated with displayed content items such as searching and downloading.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 3, network interface device 154 comprises various components used to transmit and/or receive data over a networked environment. By way of example, such components may include a wireless communications interface. When such components are embodied as an application, the one or more components may be stored on a non-transitory computer-readable medium and executed by the processing device.

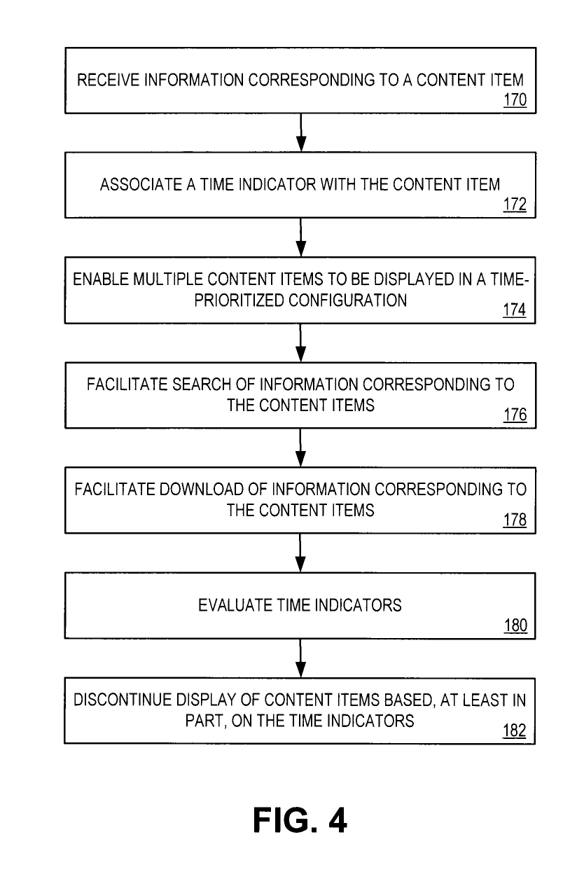

FIG. 4 is a flowchart depicting functionality that may be performed by an example embodiment of a content hosting system, such as system 160 of FIG. 3. As shown in FIG. 4, the functionality (or method) may be construed as beginning at block 170, in which information corresponding to a content item is received. For instance, the information can be provided via a content positing system such as may be implemented on a mobile device. In block 172, a time indicator is associated with the content item. Notably, the time indicator is configured to facilitate display of the content item in time-prioritized configuration, such as enabling removal of the content item from being displayed and/or facilitating presentation of the content item in receipt order. Thereafter, such as depicted in block 174, multiple content items are enabled to be displayed in a time-prioritized configuration.

In block 176, searching of information corresponding to the displayed content items is facilitated. Searching might occur via type or via searched metadata. It should be noted that a search feature may be part of an associated application resident on a wireless device that is used for interacting with the display device.

Downloading of information corresponding to the displayed content items is facilitated in block 178. In some embodiments, a user may “step through” highlighted items. That is, an indication may be made to the system corresponding to a desire to download a content item. Responsive thereto, the system may highlight content items as the user “moves through” and selects designated ones for download. Alternatively, content items may be identified, such as via use of a numeric or other identifier, that the user may enter to initiate download.

In block 180, time indicators associated with the displayed content items are evaluated. Thereafter, such as depicted in block 182, display of the content items may be discontinued based, at least in part, on the evaluation of the time indicators.

If embodied in software, it should be noted that each block depicted in the flowchart of FIG. 4 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

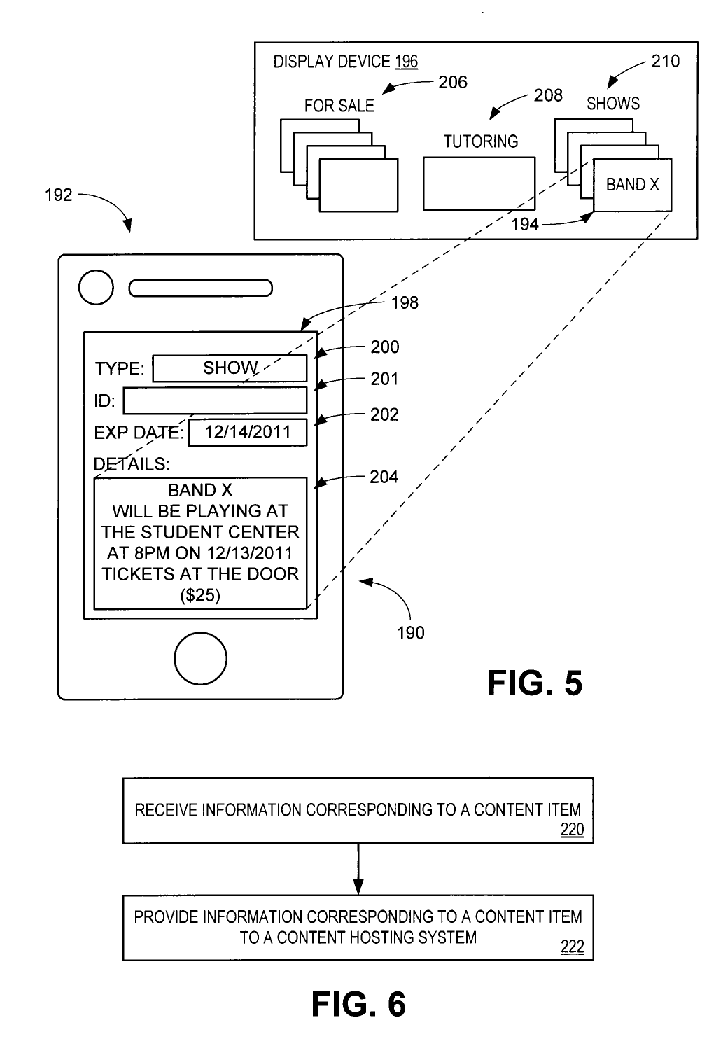

FIG. 5 is a schematic diagram of an example embodiment of a content posting system interacting with a display device of a content hosting system. As shown in FIG. 5, content posting system 190 is implemented by a mobile device 192 that is used to provide information corresponding to a content item 194 for display by display device 196.

In order to facilitate the aforementioned functionality, the content posting system provides a user interface 198. A user of the mobile device interacts with the user interface by inputting information in various fields. In this embodiment, a Type field 200, an ID field 201, an Expiration Date field 202 and a Details field 204 are provided. Clearly, various other configurations may be used, such as those involving different fields or those that do not involve fields at all.

In this embodiment, the Type field is used to provide information for categorizing content items for display. For instance, three categories of content items are depicted in the display area of the display device; specifically, a For Sale category 206, a Tutoring category 208 and a Shows category 210. In some embodiments, categories are predetermined and stored in the content posting system, as well as in the content hosting system, for use. It should also be noted that in contrast to the category placement depicted in FIG. 5, various other configurations may be used for displaying content items in other embodiments that may or may not include category groupings.

The ID field is used to identify a specific posting. The ID field may also be used, for example, to identify an item to be downloaded.

The Expiration Date field is used to provide information corresponding to a time that the user indicates is suitable for removing the content item from the display. In some embodiments, the information in the Expiration Date field may be used as the time indicator previously described. However, in some embodiments, a time indicator that does not correspond to the information provided in the Expiration Date field may be used. For instance, if the user enters a date that is beyond the predetermined display duration, information corresponding to the display duration may be used as the time indicator.

The Details field is used to provide information that is primarily used in formatting the associated content item. Options include templates in the application, templates on the posting display (that may be selected by user) and an “image” of what is on the posting display device, among others.

FIG. 6 is a flowchart depicting functionality that may be performed by an example embodiment of a content posting system, such as that associated with the embodiment of FIG. 5. As shown in FIG. 6, the functionality (or method) may be construed as beginning at block 220, in which information corresponding to a content item is received. In some embodiments, this is facilitated by user interaction with a user interface. Thereafter, such as depicted in block 222, information corresponding to the content item is provided to a content hosting system. For instance, the information may be communicated to a content hosting system via wireless communication as a user of the mobile device upon which the content posting system resides is within the vicinity of the content hosting system. Notably, proximity between the content posting system and the content hosting system may be preferred in some embodiments to promote display of local content only, in contrast to content that may otherwise be pushed to a display device from a more remote location.

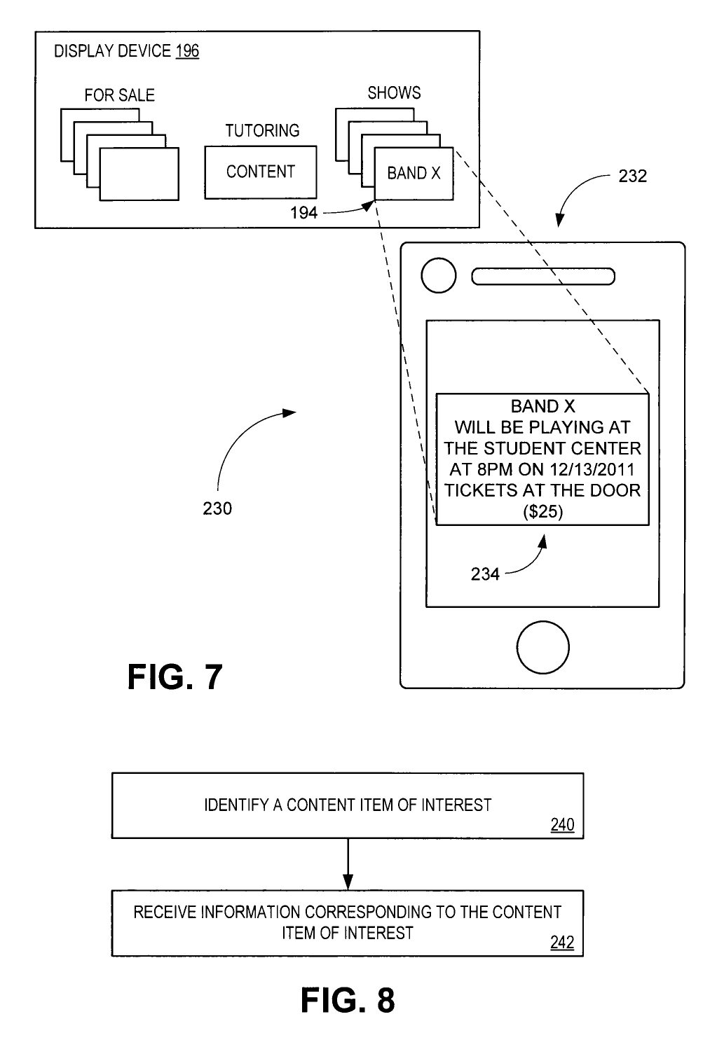

FIG. 7 is a schematic diagram of an example embodiment of a content downloading system interacting with a content hosting system. As shown in FIG. 7, content downloading system 230 is implemented by a mobile device 232 that is used to receive information corresponding to content item 194 that is being displayed by display device 196. In this embodiment, information 234 (which is identical to the information input by the user in the Details field described with respect to FIG. 5) is received by the mobile device via wireless communication with the content hosting system.

FIG. 8 is a flowchart depicting functionality that may be performed by an example embodiment of a content downloading system, such as that associated with the embodiment of FIG. 7. As shown in FIG. 8, the functionality (or method) may be construed as beginning at block 240, in which a content item of interest is identified to a content hosting system. In some embodiments, this is facilitated by user interaction with a user interface of a mobile device, whereas in other embodiments, the required interaction may be performed directly with the content hosting system, such as by designating a content item by actuating the content item on the display device. Thereafter, such as depicted in block 242, information corresponding to the content item of interest is received by the content downloading system. As such, the information may be available for use on the mobile device.

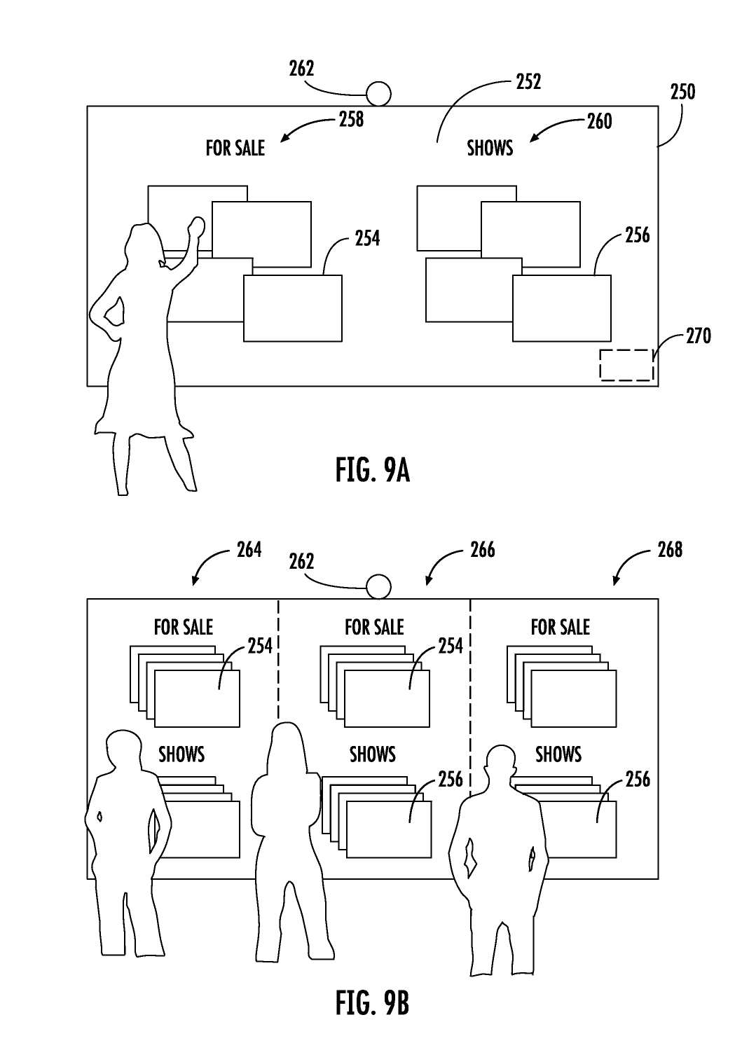

FIGS. 9A and 9B are schematic diagrams of an example embodiment of a content hosting system interacting with users. As shown in FIG. 9A, the content hosting system includes a display device 250 with a display area 252. Multiple content items (e.g. content items 254, 256) are currently displayed within the display area in a default configuration, with the content items being arranged in categories (e.g., For Sale 258 and Shows 260). Notably, in this embodiment, the default configuration is displayed when there is up to one user interacting with the display device. This configuration enables the entire display area to be used in displaying an increased amount of information associated with the content items. Note also that the content hosting system includes a camera 262. In other embodiments, multiple cameras may be used.

As shown in FIG. 9B, the display configuration has been altered to accommodate multiple users. Specifically, responsive to the content hosting system determining that three users are present, the display area is partitioned into three segments (264, 266, 268), with each of the segments providing access to all of the content items. In this embodiment, all of the content items are displayed in each of the segments for ready access by each of the users. However, also note that the orientation of the content items has been changed to better fit within the segments.

Camera 262 acquires image data in a vicinity of the display area of the display device for facilitating a determination of the number of users interacting with the display device. This image data may be used as a primary or supplemental source of information for making such a determination.

In some embodiments, a contact zone may be provided as the starting point for new initiating users. Referring once again to FIG. 9A, a contact zone 270 is depicted that a new user may actuate by touching the display device in the location of contact zone 270. Responsive to actuation of the contact zone, the content hosting system may determine that an additional user is present. This may cause the system to partition and may be accomplished without the use of a camera for determining the number of users.

In some embodiments, a user may be able to designate or “claim” an area of the display device for use. For instance, a user may identify a section of the display screen (such as by touching the area) and that section may then be designated temporarily for use by that user. Then, the user may perform various functions, such as posting, searching, and/or downloading of content items. In some embodiments, highlighting may be used to differentiate various features. For example, different user sections and/or notes from different users may be highlighted differently.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A content delivery system comprising:
a content hosting system having a wireless communication interface for communicating with mobile devices, the content hosting system being operative to:
receive information corresponding to a first content item via the wireless communication interface;
associate a first time indicator with the first content item; and
provide the first content item to a display device such that multiple content items are displayed in a time-prioritized configuration.

2. The system of claim 1, wherein the content hosting system is further operative to display the first content item in front of at least a portion of a second content item displayed by and previously provided to the display device.

3. The system of claim 1, wherein the content hosting system is further operative to prevent display of the first content item responsive to determining that the first time indicator correlates with a content display duration.

4. The system of claim 1, further comprising a content posting system operative to produce the information corresponding to the first content item and provide the information to the content hosting system.

5. The system of claim 1, wherein:
the content delivery system further comprises a mobile device; and
the content posting system is resident on the mobile device.

6. The system of claim 1, further comprising a content downloading system operative to download information corresponding to the first content from the content hosting system.

7. The system of claim 1, further comprising the display device.

8. The system of claim 7, wherein the content hosting system is further operative to determine a current number of users of the display device and partition a display area of the display device into multiple segments based, at least in part, on the number of users determined.

9. The system of claim 8, wherein:
the content delivery system further comprises a camera operative to acquire image data associated with users of the display device; and
the content hosting system is further operative to receive the image data and determine the current number of users therefrom.

10. The system of claim 7, wherein the content hosting system is further operative to enable a user to claim an area of the display device for use.

11. A method for displaying prioritized content comprising:
receiving, via a wireless communication interface, information corresponding to multiple content items from at least a first mobile device; and
displaying, via a display device, the multiple content items in a time-prioritized configuration, in which a first of the content items is displayed in front of at least a portion of a second of the content items, the first of the content items having been received more recently than the second of the content items.

12. The method of claim 11, further comprising discontinuing display of the second of the content items responsive to determining that a display time for the second of the content items has expired.

13. The method of claim 12, wherein:
the method further comprises associating a time indicator with the second of the content items; and
determining that a display time for the second of the content items has expired further comprises evaluating the time indicator.

14. The method of claim 13, wherein the time indicator corresponds to a time at which display of the second of the content items is to be discontinued from display.

15. The method of claim 13, wherein the time indicator corresponds to a time at which the second of the content items was received.

16. The method of claim 11, further comprising providing information corresponding to the first of the content items to a mobile device.

17. The method of claim 11, further comprising facilitating, at the display device, searching of information contained in the multiple content items.

18. The method of claim 11, wherein displaying further comprises arranging the multiple content items according to predetermined content categories.

19. The method of claim 11, wherein displaying further comprises partitioning a display area of the display device into multiple segments, each of the segments of the display area providing a separate user interface for interacting with the multiple content items.

20. The method of claim 19, wherein partitioning further comprises determining a current number of users of the display device and partitioning the display area based, at least in part, on the number of users determined.
